(19) United States
(12) Patent Application Publication
(10) Pub. No.: US 2021/0211088 A1
(43) Pub. Date: Jul. 8, 2021

(54) LOW TECH HIGH OUTPUT PV-ROOF-SYSTEM

(71) Applicant: PIP CAPITAL B.V., Enschede (NL)

(72) Inventor: Callistus Franciscus Antonius PETERS, Enschede (NL)

(73) Assignee: PIP CAPITAL B.V., Enschede (NL)

(21) Appl. No.: 17/059,176

(22) PCT Filed: May 23, 2019
(86) PCT No.: PCT/NL2019/050299

§ 371 Date: Nov. 25, 2020

(30) Foreign Application Priority Data
May 28, 2018 (NL) 2020992

(51) Int. Cl. H02S 20/25; H02S 40/32

(52) U.S. Cl. CPC H02S 20/25; H02S 40/32

(57) ABSTRACT

The present invention is in the field of a low tech high output PV-roof-system, specifically (photo)voltaic systems, which may be applied on a roof, but being equally suited for building wails and building facades and so on, a product comprising said system, and buildings comprising said systems providing improved electrical energy conversion.

This application is a national entry of International Patent Application WO2019/231314 A1, filed May 23, 2019, in the name of “Weijland Holding B.V.”, which PCT-application claims priority of Netherlands Patent Application with Serial No. 2020992, filed May 28, 2018, in the name of “Weijland Holding B.V.”. The entire contents of the above-referenced applications and of ail priority documents referenced in the Application Data Sheet filed herewith are hereby incorporated by reference for all purposes.

### STATEMENT REGARING FEDERALLY SPONOSRED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### FIELD OF INVENTION

The present invention is in the field of a low tech high output PV-roof-system, specifically (photo)voltaic systems, which may be applied on a roof, but being equally suited for building walls and building facades and so on, a product comprising said system, and buildings comprising said systems providing improved electrical energy conversion.

### BACKGROUND OF THE INVENTION

In the field of energy conversion PV-systems are known. These systems generally use a PN-junction to convert solar energy to electricity.

A disadvantage of such a system is that the conversion per se is not very efficient, typically, for Si-solar cells, limited to some 25%. Even using very advanced PV-cells, such as GaAs cells, the conversion is only about 30%. Inherently these systems are limited in their conversion.

A final efficiency is further limited by an electrical chain of components, such as a current collector on a PV-panel, wires between components, an DC/AC converter, non-optimal functioning cells, such as due to shading or (partly) malfunction, an attempt to achieve maximal power point tracking within too limited boundary conditions, which boundary conditions are often not met and as a consequence efficiency drops significantly, fluctuations in output per cell and/or per panel which are difficult to cope with, and so on. Typically a PV-panel or system comprising panels therefore only reaches about 80% of its optimal output under practical conditions.

In addition PV-panels are provided in standard sizes and in a standard rectangular shape, which by definition do not fit to an available space, such as on a roof. In addition, for these panels large areas of a roof are not suited for PV-conversion as a final efficiency is too low and hence the panels are not economical viable.

The panels are further provided on a roof, and need to be attached to a roof, which is labour intensive. Systems typically also need to be installed. Such installation is complex in nature, requires piping and/or cabling, and is expensive. Also, complex mounting systems for PV systems onto buildings result in increased failure rates and increased installation costs. Such contributes significantly to the costs of ownership and hence to the economic viability. The provision of panels on a roof may be considered not visually attractive and hence a motivation not to apply the panels.

Further these systems are somewhat expensive to manufacture, as well as components thereof, such as electronics.

So existing PV systems show huge power losses, and significant quantities of generated power are not usable because of e.g. too low power at low light conditions, due to dirty cells, and shading, effecting the total output of a PV-module.

Some prior art may be mentioned. DE 10 2010 019815 A1 shows a photovoltaic system comprising roof elements. Said system operates at a low frequency, which introduces noise, at least in frequencies that can be observed by animals, such as birds. WO 2014/120002 A1 of the present inventor relates to a Photovoltaic system and Intelligent cell current converter technology.

Thus there still is a need for an improved energy conversion system, which system overcomes one or more of the above disadvantages, while at the same time not jeopardizing other favourable aspects of energy conversion.

### SUMMARY OF THE INVENTION

The present invention relates system, comprising a multitude of roof elements 1, at least two roof element receivers 2 for receiving and supporting a row of at least two roof elements 1, and at least one rafter 3 for supporting at least one roof element receiver. Though throughout the application reference is made to a roof, the roof element, and likewise the rafter and receiver, are equally applicable to other typically substantially flat surfaces, such as building walls, facades, green houses, and so on. The present roof element may be fixed and mounted without use of typical fixation elements, such as bolts, screws. Glue or kit. Thereto the present roof element may be provided with a hook. The present roof element is adapted to convert light into electrical power, hence being photo-voltaic. Typical voltages per cell are in the order of 0.3-2 V; for Si based cells voltages are typically in the order of 0.5 V. Voltages over cells may be added. Per roof element typically currents of cells present are collected, typically in series or in parallel. In addition power of roof elements may be coupled in series, in parallel, or a combination thereof; for instance left and right elements may be coupled, or lower and higher elements may be coupled. Coupling of solar power may be wireless or including contacts. The roof element comprises a matrix of PV-cells, a PV-cell typically having dimensions of 5-20 cm by 5-20 cm, such as 10 by 10 cm and a thickness of less than 1 mm. Further electronics and a DC-AC converter per roof element are provided. The converter provides AC-output. The roof element comprises a primary end of a first transformer; as such the first transformer is physically “split” into two parts, the primary end being part of the roof element. The two parts of the first transformer are spatially separated, preferably at a very small distance of 0.05-100 mm, more preferably at a distance of 0.1-10 mm, even more preferably at a distance of 0.5-5 mm, such as 1-2 mm. The distance is somewhat difficult to control in practice as variations in dimensions of roof elements naturally occur, such as in view of production limitations, a roof (or similar) surface is typically not fully fiat such as slightly curved, and application of roof elements may also bring variations. As a consequence the roof element and roof receiver may not be fully aligned. In this respect it is noted that in construction typical tolerances used are in the order of centimetres, making it inherently somewhat complicated to achieve full alignment. The present roof element receiver comprises a secondary end of a first transformer for each roof element, therewith providing transfer of power and transformation of power. The first transformer multiplies the voltage by a factor of >2, typically by a factor >5, such as >10. Each first transformer multiplies the voltage typically by a same factor, such that a same voltage is provided over two primary conductors. The outputs of the secondary end of the first transformer of roof elements are electrically connected in parallel. The roof element receiver comprises at least two electrical primary conductors provided over a length of the roof element receiver, typically over a full length, the primary conductors intended for transferring power. The present system further comprises at least one rafter, typically at least two, for supporting roof element receivers, the rafter and roof element receivers typically forming a frame, typically an open frame of which the receivers and rafters form sides thereof. The rafter comprises at least two electrical secondary conductors, typically provided over a length of the rafter, typically over a full length, the secondary conductors intended for transferring power. As such a chain comprising transformers and primary and secondary conductors is provided, being in electrical contact with one and another, for transferring power.

Amongst others the present system collects all generated power and converts generated power into usable power. The PV system is relatively insensitive for shading effects, causing detrimental effects in e.g a series of cells, apart from cells not providing a current due to lack of solar radiation. Furthermore at low light conditions difficult to harvest power is converted into usable power. By using the present system the power generation of a PV system increases 10-20% in comparison to the conventional PV systems and 5-15% in comparison to PV systems with micro-inverters. The present system is very efficient (>95% efficiency), typical 98% under all conditions. The electronics used can be produced at low cost for economy of scale quantities. The electronics are very robust since it uses conventional electrical components with a proven stability at extreme climate conditions over time (>20 years).

The present system is an easy to install (Plug and Play) PV mounting system based on a partly Wireless Power Transfer (WiPoT) approach. at high conversion efficiencies. Using the WiPoT one end of the transmission module (typically the primary winding) may be located in or attached to the voltaic unit, whereas another end (typically the secondary winding) may be attached to e.g. the power grid. For sake of efficient installation magnets may be provided, such as one at each end, for establishing (electro-mechanical) connection between a first and second end of the Wi-PoT. The system can be used as stand-alone system (with. e.g. electrical energy storage means) and as (part of) a grid, being connected to buildings, or a micro grid.

By using the present voltaic system, in particular a PV-system, a user thereof becomes less dependent of energy suppliers and its fluctuating energy prices in fact a (largely) stable pricing is established. It is noted that the return of investment costs due to reduced electricity costs is with current prices already within reasonable reach, and with the present system, especially when building integrated, a profitable business case is being established.
a. The present system can be placed on a building, e.g. on a roof or a wall thereof, the roof and wall forming a surface, or be part thereof, e.g. a roof tile. Likewise the present system can form part of larger PV-systems. The present system can also form a part of a further product. By largely integrating the present system into e.g. a building it may become more aesthetically attractive. Even further, integration in novel or refurbished buildings can reduce the costs thereof as the present system may have more than one function, e.g. conversion of light into energy and protection of a building against influences of the environment.

The present system is adapted to gather electrons in a relative broad power range, starting at a relatively low power. Thereby e.g. the efficiency, total output (over e.g. a year), threshold, performance in non-optimal weather conditions (cloudy weather) are improved significantly.

The present wireless power transmitter provides for lower costs for the system, as no or less cables are needed, maintenance is reduced, and lower costs of installation, e.g. because a place-and-click system may be used, such as roof and wall systems.
a. As such the present invention overcomes one or more of the above problems and/or disadvantages.

Various elements of e present apparatus as well as advantages will be discussed below in detail.

### DETAILED DESCRIPTION OF THE INVENTON

In a first aspect the present invention relates to a voltaic system according to claim 1.

In an exemplary embodiment the present invention relates to a photovoltaic unit. However, in principle the invention may be applicable to any e.g. in electrical terms similar, voltaic unit. As such the present invention relates to such voltaic units in general.

In an exemplary embodiment of the present PV-system the roof element receiver may comprise a hollow part 25 for guiding the at least two primary conductors.

In an exemplary embodiment of the present PV-system the first transformer 11 may be adapted to multiply a voltage of the roof element by a factor 5-200, preferably 10-50, such as 14-30, such as from 1.5 V to 10.5V, from 2 V to 14 V, and likewise to 28 V, or from 2V or 3 V to 400 V.

In an exemplary embodiment of the present PV-system the roof element receiver may comprise a primary end of at least one second transformer 21 and wherein the rafter may comprise a secondary end of the second transformer 22 for AC/DC conversion, wherein the second transformer 21 may be adapted to multiply a voltage of the roof element receiver by a factor 5-100, preferably 10-50, such as 14-30.

and second electronics 34, preferably located at an end of the roof element.

In an exemplary embodiment the present PV-system may comprise at least one roof element receiver per row of roof elements, such as 2-3 roof element receivers.

In an exemplary embodiment the present PV-system may comprise at least 2-10 rafters.

In an exemplary embodiment the present. PV-system may comprise at least one DC/AC converter 6 being in electrical contact with the at least one rafter and with a metering cupboard.

In an exemplary embodiment of the present PV-system the first electronics 14 comprises at least one transistor 18 in electrical contact with the roof element and with the primary side of the first transformer, such as a FET, such as a MOSFET and JFET.

In an exemplary embodiment of the present PV-system the one or more transistors, preferably one or more FETs, may operate within a limited operating voltage range, such as from 0.75-1.25 V, preferably from 0.9-1.1 V, such as from 0.95-1.05 V. In an alternative an operating voltage range is chosen to be 0.25-0.75 V, preferably from 0.4-0.6 V, such as 0.5V. An advantage thereof is that it can operate at much lower current and/or voltage, thereby reducing e.g. energy losses.

In an exemplary embodiment of the present PV-system each roof element may comprise two first transformers 11.

In an exemplary embodiment of the present PV-system each roof element independently may comprise 1*2 to 27*27 photo-voltaic cells, preferably 2*2 to 26*26 photo-voltaic cells, more preferably 2*4 to 25*25 photo-voltaic cells, even more preferably 4*2 to 24*24 photo-voltaic cells, such as 12-72 photo-voltaic cells.

In an exemplary embodiment of the present PV-system PV-cells may be attached to the roof element, such as by an adhesive.

In an exemplary embodiment of the present PV-system PV-cells may be provided as a sheet, preferably a polymer based sheet.

In an exemplary embodiment of the present PV-system the roof element may be selected from a roof tile, and an ethernite plate.

In an exemplary embodiment of the present PV-system the first transformer may comprise a capacitor, a MOSFET, a diode in series, and a podcore.

In an exemplary embodiment of the present PV-system the second transformer may comprise a capacitor, a MOSFET, a diode in series, and a podcore.

The diode is found to protect the electronics. In experiments so far it protected all transformers against malfunction.

In an exemplary embodiment of the present PV-system the oscillator 14a may be adapted to operate at a frequency of 60-200 kHz, such as 80-120 kHz.

In an exemplary embodiment of the present PV-system may be for providing a variable current and a constant voltage having at least two photo-voltaic units in parallel, or combinations thereof.

In an exemplary embodiment of the present PV-system the one or more PC-cells may be selected from single junction and multi junction semiconductor PV-cells, such as Si-cells, III-IV -cells, thin film solar cells, such as CdTe, CuInGaSe, GaAs, organic cells, polymer cells, dye solar cells, back contact systems, and combinations there-of.

In an exemplary embodiment of the present PV-system the first and second transformer, or the primary end and secondary end thereof, may be provided as planar transformer, preferably as a PCB-laminated transformer.

In an exemplary embodiment of the present PV-system the product may be adapted to be used in series and/or in parallel, and wherein the product has at least one of a random size, a regular shaped size, wherein the regular shape size may be selected from rectangular, circular, multicional, hexagonal, octagonal, and in at least one dimension a curved surface.

in an exemplary embodiment of the present PV-system the roof element and/or roof element receiver may comprise an aligner.

In an exemplary embodiment of the present PV-system the roof element may be a tile for protecting against wind and rain.

In an exemplary embodiment the present product may comprise a Photo-voltaic system according to the invention, wherein the product is preferably selected from an off-grid system, a solar farm, a stand-alone system, and combinations thereof.

In an exemplary embodiment the present product or building element may further comprise domotica. Therewith demand and supply can be optimised, e.g. in terms of amount stored, capacity of components, etc.

In an exemplary embodiment the present product or building element may further comprise an energy storage.

In an exemplary embodiment the present product or PV-system provides improved power output.

In a further aspect the present invention relates to a kit of parts comprising at least one of (i) a roof element, the roof element comprising a primary end of a first transformer, and a matrix of PV-elements, each PV-element comprising at least one PV-cell, electronics, a DC-AC converter per roof element, and an AC-output, (ii) a roof element receiver, the roof element receiver comprising a secondary end of a first transformer for each roof element, at least two electrical primary conductors provided over a length of the roof element receiver, (iv) at least one rafter for supporting roof element receivers, (v) at least two electrical secondary conductors, such as a tube, (vi) a hollow part for guiding the at least two primary conductors, such as a tube, (vii) first electronics 14, (viii) second electronics 34, and (ix) a DC/AC converter 6

The invention is further detailed by the accompanying figures, which are exemplary and explanatory of nature and are not limiting the scope of the invention.

### SUMMARY OF THE FIGURES

FIG. 1-4 show details of the present system.

FIG. 5 shows a harvester core circuit example.

FIG. 6 shows an electronic layout of electronics for the first transformer or second transformer.

FIG. 7 shows an example of a power input current measurement circuit (primary side) with connectors and capacitors.

FIG. 8 shows an exemplary power output current measurement circuit with output connectors and output capacitors.

FIG. 9 shows electro-magnetic connections.

### DETAILED DESCRIPTION OF THE FIGURES

In the figures:

10 Photo-voltaic system

roof element

roof element receiver (lath)

rafter

hook

DC/AC converter

11 first transformer
12 secondary end of first transformer

### 13 PV-element

### 13a PV-cell

13b PV cell
14 first electronics
14a oscillator
15 AC output
18 transistor
21 second transformer
22 secondary end of secondary transformer
25 output
26 primary conductor
34 second electronics
36 secondary conductor

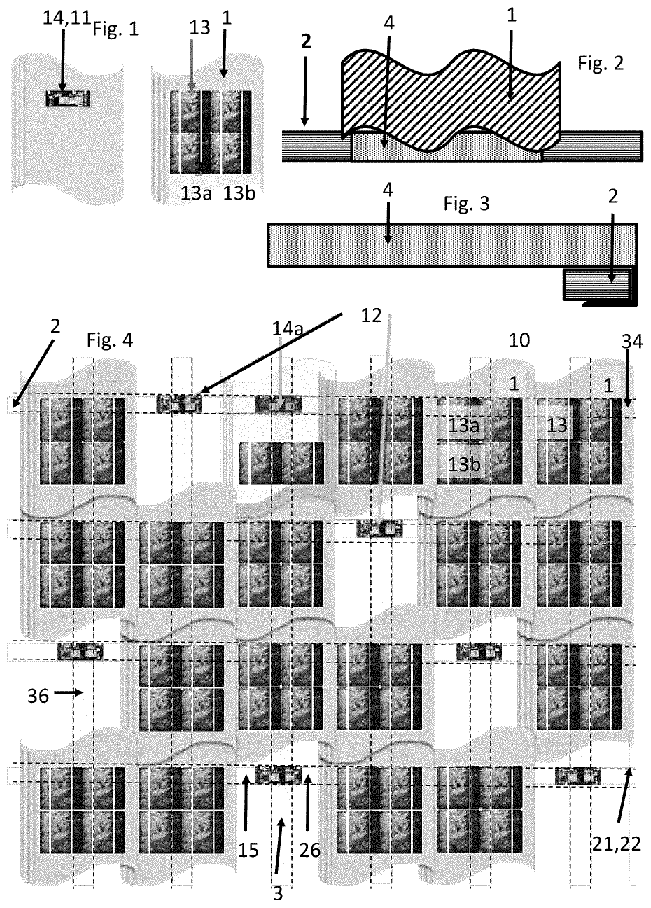

In FIG. 1 (left) a back side of a roof tile with first electronics (primary end) and (right) a front side comprising 4 PV-cells is shown.

In FIG. 2 a roof element 1 is shown which is being attached to a lath by a hook element 4.

In FIG. 3 a side view of the hook element 4 attached to the lath 2 is show. The attachment system is very simple in use.

FIG. 4 shows details of the present system, including roof receiving elements 2, oscillator 14a, secondary ends of the first transformer 12, second electronics 34, secondary conductor 36, AC output 15, which may also be a DC output if optional oscillator 14a is not present, primary conductor 26, and second transformer 21 with secondary end 22 thereof.

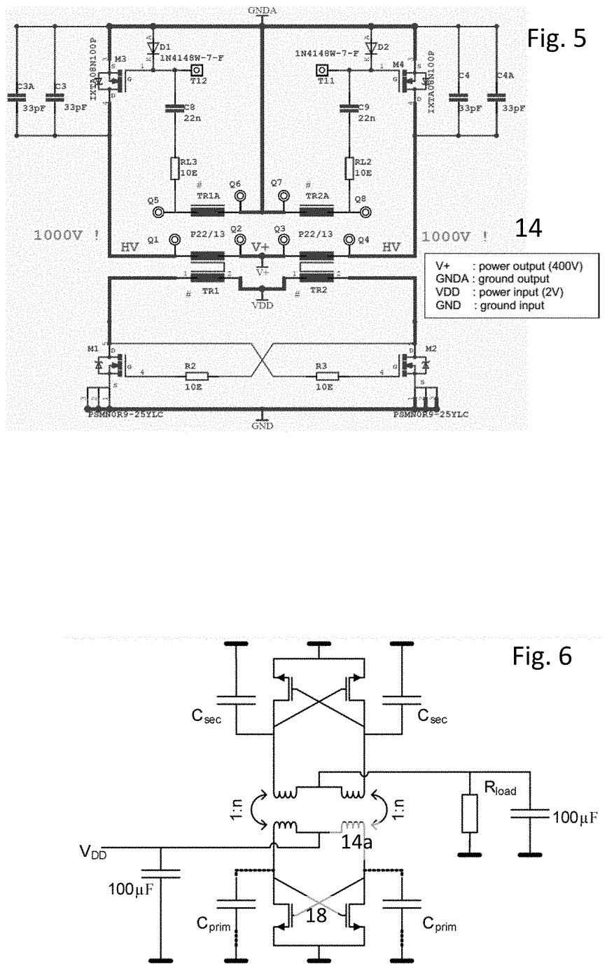

FIG. 5 shows a harvester core circuit example.

FIG. 6 shows an electronic layout of electronics for the first transformer, which is, independently, equally applicable to the second transformer.

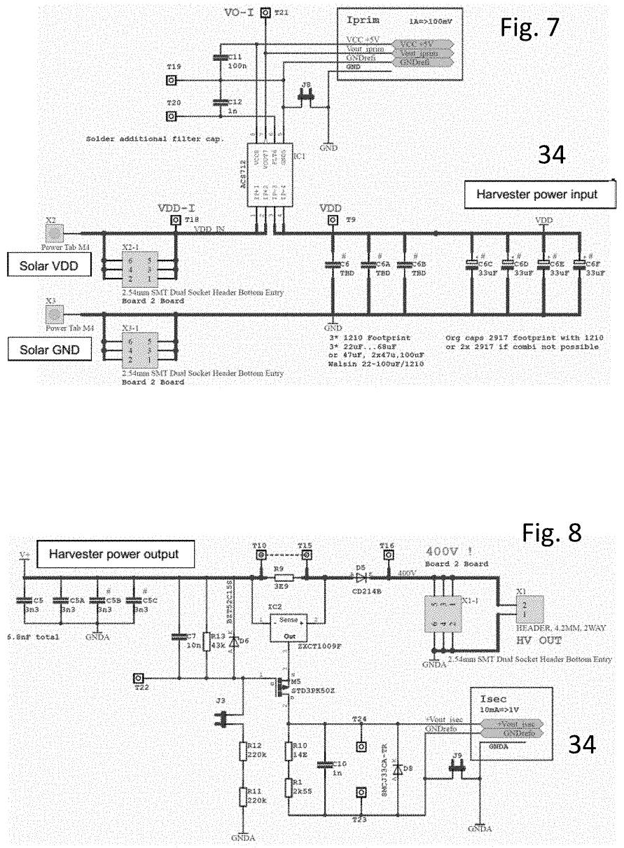

FIG. 7 shows an example of a power input current measurement circuit (primary side) with connectors and capacitors.

FIG. 8 shows an exemplary power output current measurement circuit with output connectors and output capacitors.

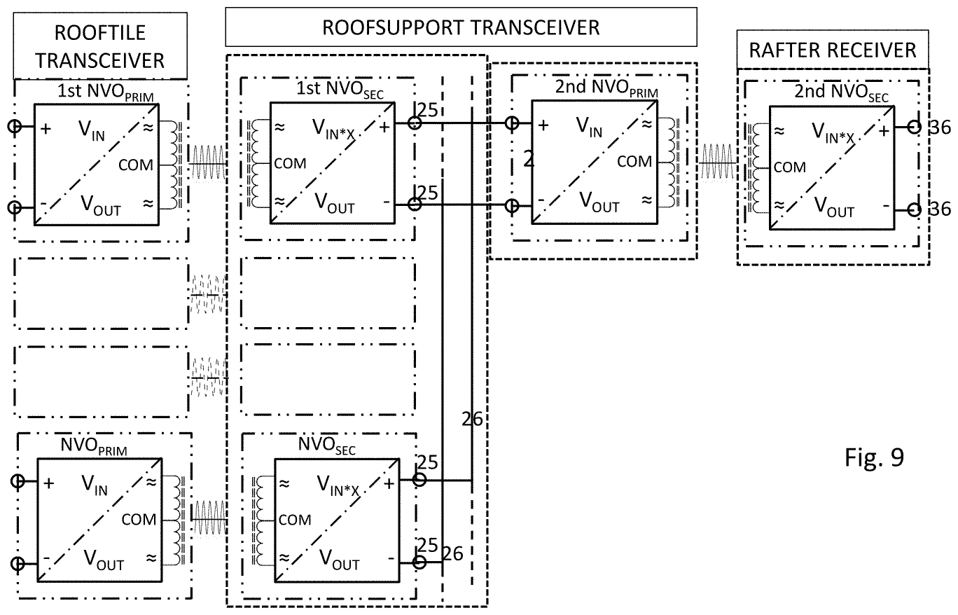

FIG. 9 shows electro-magnetic connections between PV cells (left + and −), through primary end of first nanovoltage transformer to secondary end thereof, provided in the rafter. Electrically connecting all secondary ends of the first transformer, providing that output to the primary end of the second transformer, provided opposite of the rafter, and receiving the output in the secondary side of the second transformer.

1. A photo-voltaic system comprising:
a multitude of roof elements, at least two roof element receivers for receiving and supporting a row of at least two roof elements, and at least one rafter for supporting at least one roof element receiver;
the roof element comprising a primary end of at least one first transformer for optional DC-AC conversion per roof element, the first transformer adapted to provide DC- or AC-output, and a matrix of PV-elements, each PV-element comprising at least one PV-cell;
first electronics, the first electronics comprising at least one transistor in electrical contact with the roof element and with the primary side of the first transformer, and an oscillator, wherein the oscillator is adapted to operate at a frequency of 60-200 kHz;
each roof element receiver comprising a secondary end of each first transformer for each roof element spatially separated from the primary end, each first transformer independently multiplying the voltage by a factor of >2, the outputs of the secondary end of the first transformers of a row of roof elements being electrically connected in parallel, and at least two electrical primary conductors provided over a length of the roof element receiver; and
each rafter comprising at least two electrical secondary conductors in electromagnetic contact with the primary conductors.

2. The photo-voltaic system according to claim 1, wherein the roof element receiver comprises a hollow part for guiding the at least two primary conductors.

3. (canceled)

4. The photo-voltaic system according to claim 1, wherein the roof element receiver comprises a primary end of at least one second transformer and wherein the rafter comprises a secondary end of the second transformer for AC/DC conversion, wherein the second transformer is adapted to multiply a voltage of the roof element receiver by a factor 5-100; and
second electronics, located at an end of the roof element.

5. The photo-voltaic system according to claim 1, comprising at least one roof element receiver per row of roof elements.

6. (canceled)

7. The photo-voltaic system according to claim 1, comprising at least one DC/AC converter (6) being in electrical contact with the at least one rafter and with a metering cupboard.

8. The photo-voltaic system according to claim 1, wherein the transistor is selected from a FET, a MOSFET, and JFET.

9. The photo-voltaic system according to claim 1, wherein each roof element comprises two first transformers.

10. (canceled)

11. The photo-voltaic system according to claim 1, wherein PV-cells are attached to the roof element.

12. The photo-voltaic system according to claim 1, wherein PV-cells are provided as a sheet.

13. The photo-voltaic system according to claim 1, wherein the roof element is selected from a roof tile, and an ethernite plate.

14. The photo-voltaic system according to claim 1, wherein the first transformer comprises a capacitor, a MOSFET, a diode in series, and a podcore.

15. The photo-voltaic system according to claim 1, wherein the second transformer comprises a capacitor, a MOSFET, diode in series, and a podcore.

16. The photo-voltaic system according to claim 1, wherein the oscillator is adapted to operate at a frequency of 80-120 kHz.

17. The photo-voltaic system according to claim 1, for providing a variable current and a constant voltage having at least two photo-voltaic units in parallel, or combinations thereof.

18. (canceled)

19. The photo-voltaic system according to claim 1, wherein the first and second transformer, or the primary end and secondary end thereof, are provided as planar transformer.

20. The photo-voltaic system according to claim 1, wherein the system is adapted to be used in series, and in parallel, and wherein the system has at least one of a random size, a regular shaped size, wherein the regular shape size is selected from rectangular, circular, multigonal, hexagonal, octagonal, and in at least one dimension a curved surface.

21. The photo-voltaic system according to claim 1, wherein the roof element and roof element receiver comprise an aligner.

22. (canceled)

23. A product comprising the photo-voltaic system according to claim 1, wherein the product is selected from an off-grid system, a solar farm, a stand-alone system, and combinations thereof.

24. (canceled)

25. (canceled)

26. (canceled)

27. (canceled)
